(19) United States
(12) Patent Application Publication
(10) Pub. No.: US 2011/0157236 A1
(43) Pub. Date: Jun. 30, 2011

(54) HEAD-MOUNTED DISPLAY

(75) Inventor: Hiroshi INOUE, Nisshin-shi (JP)

(73) Assignee: BROTHER KOGYO KABUSHIKI KAISHA, Nagoya-shi (JP)

(21) Appl. No.: 12/967,595

(22) Filed: Dec. 14, 2010

(30) Foreign Application Priority Data
Dec. 24, 2009 (JP) 2009-292163

(51) Int. Cl. G09G 5/00

(52) U.S. Cl. 345/689

(57) ABSTRACT

A head-mounted display includes an image display that is mounted on the head of a user and permits the user to visually recognize an image, input detector that is mounted on the body of the user to detect coordinates of input by a user in a detection area, an image generation unit that generates a trajectory image of the input based on the coordinates of input and output this generated trajectory image to the image display, a displacement determination unit that determines a relative displacement of the character written into the detection area from the coordinates of input, and a position correction unit that corrects the displacement of the character based on the displacement.

### BACKGROUND OF THE DISCLOSURE

1. Field of the Disclosure

The present invention relates to a head-mounted display capable of displaying input performed by a user.

2. Description of the Related Art

Conventionally, an electronic pen is proposed which can electronically generate a trajectory of input performed by the user and save it. On the other hand, a device is proposed which permits the user to write/draw with the pen onto a virtual image indicated on a head-mounted display.

### SUMMARY OF THE DISCLOSURE

The conventional electronic pens have a problem in that they would write/draw onto a two-dimensional input screen and so have no hands-free capabilities, lacking in mobility. On the other hand, the device permitting the user to write/draw with a pen onto a virtual image indicated on the head-mounted display is hands-free and excellent in mobility because the user would process the virtual image by using the pen. However, this device would suffer a problem in that the user could not easily write/draw onto the virtual image because s/he may find it difficult to grasp the sense of distance to the virtual image.

To solve the problem, such a configuration may be possible that the user would be mounted at his/her waist, etc. with an input screen to detect the input of the user and, further, those may appear on a head-mounted display. With this configuration, although the user cannot directly recognize this input screen visually, s/he can confirm his/her own input on the head-mounted display without deteriorating the mobility of the electronic pen.

However, when writing characters to the input screen, the user cannot easily recognize the input screen visually because of his/her posture, so that a problem occurs in that the characters written by the user may be displaced obliquely or overlapped with each other, to disable electronically generate a trajectory of those characters as s/he desires.

The present invention provides a head-mounted display that solves the above problems to permit the user to electronically generate the his/her-desired trajectory of characters.

To solve the problems, an aspect of the invention includes: an image display mounted on the head of a user and permits the user to visually recognize an image;

an input detector mounted on the body of the user, and the input detector has a two-dimensional detection area that detects input coordinates which are the coordinates of input by the user;

an operation part that receives an operation of the user;

a processor that executes instructions grouped into functional units, the instructions including:

an image generation unit generating a trajectory image of input based on the input coordinates, and the image generation unit outputs the trajectory image to the image display;

a character selection unit that selects whether the input by the user is a character input through an operation to the operation part;

a displacement determination unit, when the character input is selected by the character selection unit, determining a displacement of the character input into the two-dimensional detection area with respect to a first direction in the two-dimensional detection area by the input coordinates; and

a position correction unit correcting the displacement of the character based on the displacement determined by the displacement determination unit.

### BRIEF DESCRIPTION OF THE DRAWINGS

FIG. 1 is an overall view of a head-mounted display showing an embodiment of the present invention;

FIG. 2 is an explanatory diagram showing an outline of the present invention;

FIG. 3 is a block diagram of the head-mounted display;

FIG. 4 is a flowchart of main processing;

FIG. 5 is an explanatory diagram of mode selection;

FIG. 6 is an explanatory diagram of when determining initial position coordinates;

FIG. 7 is an explanatory diagram of a writing start state;

FIG. 8 is an explanatory diagram of coordinate conversion processing;

FIG. 9 is an explanatory diagram of a state in which input by a user comes close to an edge of a detection area;

FIG. 10 is an explanatory diagram of a notification state;

FIG. 11 is an explanatory diagram of a state in which the coordinate conversion processing is performed again;

FIG. 12 is a flowchart of correction processing of a first embodiment;

FIG. 13 is an explanatory diagram of character overlapping correction;

FIG. 14 is an explanatory diagram of character tilt correction;

FIG. 15 is an explanatory diagram of acceleration displacement correction;

FIG. 16 is an explanatory diagram of the character tilt correction processing of the first embodiment;

FIG. 17 is a flowchart of an explanatory diagram of the correction processing of a second embodiment; and

FIG. 18 is an explanatory diagram of the character tilt correction processing of the second embodiment.

### DESCRIPTION OF THE EMBODIMENTS

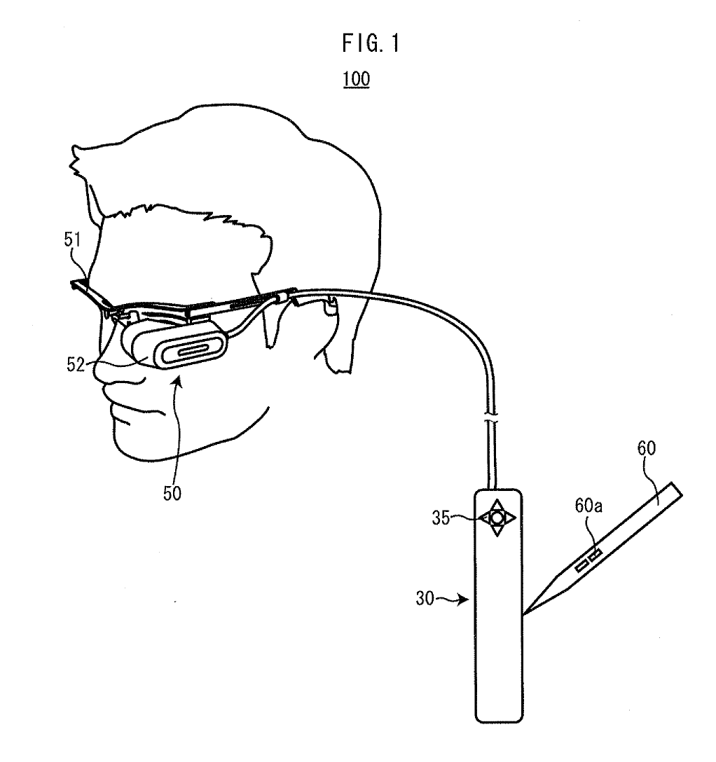

Embodiments of the invention and their features and technical advantages may be understood by referring to FIGS. 1 to 18, like numerals being used for like corresponding portions in the various drawings.

### (Outline of Head-mounted Display)

As shown in FIG. 1, a head-mounted display 100 includes a head-mounted display part 50 mounted on the head of a user and a control part 30 worn on the body such as the waist of the user. The head-mounted display part 50 includes a head-worn part 51 and an image display 52. The head-worn part 51 is eyeglass frame shaped in an embodiment shown in FIG. 1. However, the head-worn part 51 may be of any structure such as a helmet shape as long as it can be worn on the head of the user.

The image display 52 is attached to the side front portion of the head-worn part 51. The image display 52 is used to generate an image so that this image may be visually recognized by the user. In the present embodiment, the image display 52 is a retina-scanning type display that applies a laser beam directly to the eyeball of the user so that the user may visually recognize the image. It is to be noted that the image display 52 might as well by any other device such as a liquid crystal display (LCD) or an organic electroluminescence display.

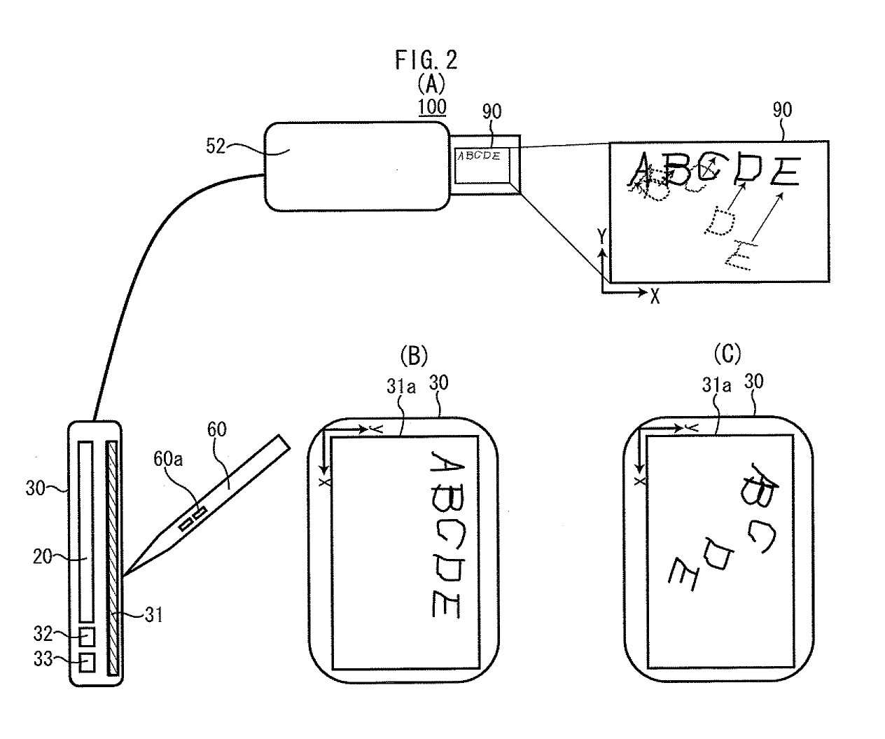

The control part 30 is a device configured to detect input by the user and generate a trajectory image of those when they are displayed on the image display 52. The control part 30 is interconnected with the image display 52. The control part 30 is equipped with an operation part 35 configured to operate the head-mounted display 100. The control part 30 is fitted with a input detector 31 as shown in FIG. 2. The input detector 31 is a device configured to detect coordinates of the input by the user in a two-dimensional detection area 31a. In the present embodiment, when the user writes/draws into the detection area 31a by using a pen 60, coordinates of this input in the detection area 31a will be detected by the input detector 31 as coordinates of the input.

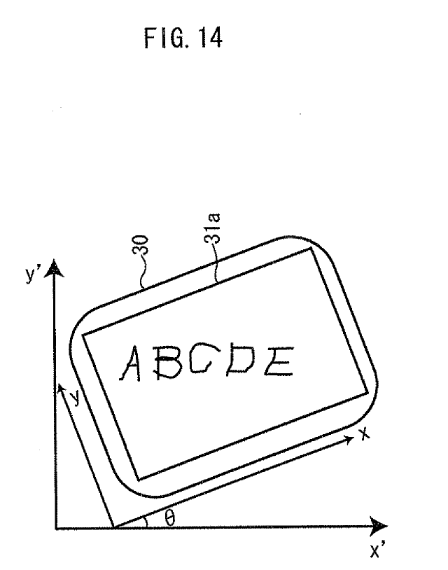

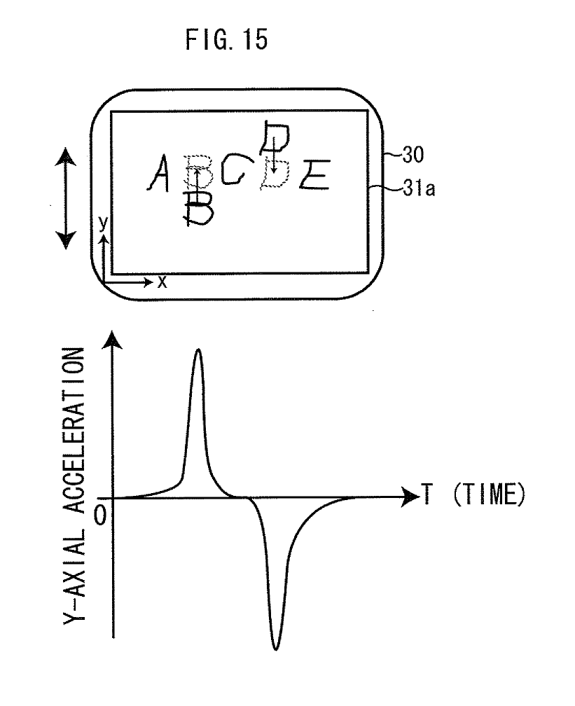

The absolute coordinates (x, y) of the detection area 31a agree with the absolute coordinates (X, Y) of a display area 90 of the image display 52. When the user writes/draws into the detection area 31a by using the pen 60 (which is shown in FIG. 2 (B)), the input by use of this pen 60 is detected in the input detector 31 and, as shown in FIG. 2 (A), a trajectory of the input by the user appears in the display area 90 of the image display 52. In a case where the control part 30 is worn on the waist of the user, the user writes characters from the top to the bottom (from the negative x direction to the positive x direction) of the detection area 31a as shown in FIG. 2 (B). The user cannot recognize the detection area 31a visually, so that the characters written in the detection area 31a may overlap with each other or be displaced from each other as shown in FIG. 2 (C). Further, as shown in FIG. 14, when the control part 30 is tilted with respect to a horizontal or vertical line, the characters written in the detection area 31a may be tilted. Further, when the user writes/draws into the detection area 31a while, for example, the user is walking, the control part 30 swings vertically, so that the characters written in the detection area 31a may be displaced from each other as shown in FIG. 15. In the present invention, the positions of overlapped, displaced, or tilted characters written into the detection area 31a in such a manner will be corrected by the control part 30 so that those characters written in this detection area 31a may be displayed on the image display 52 in a condition where they are aligned with each other as shown in FIG. 2 (A). The following will describe in detail the head-mounted display 100 that realizes those functions.

### (Block Diagram of Head-mounted Display)

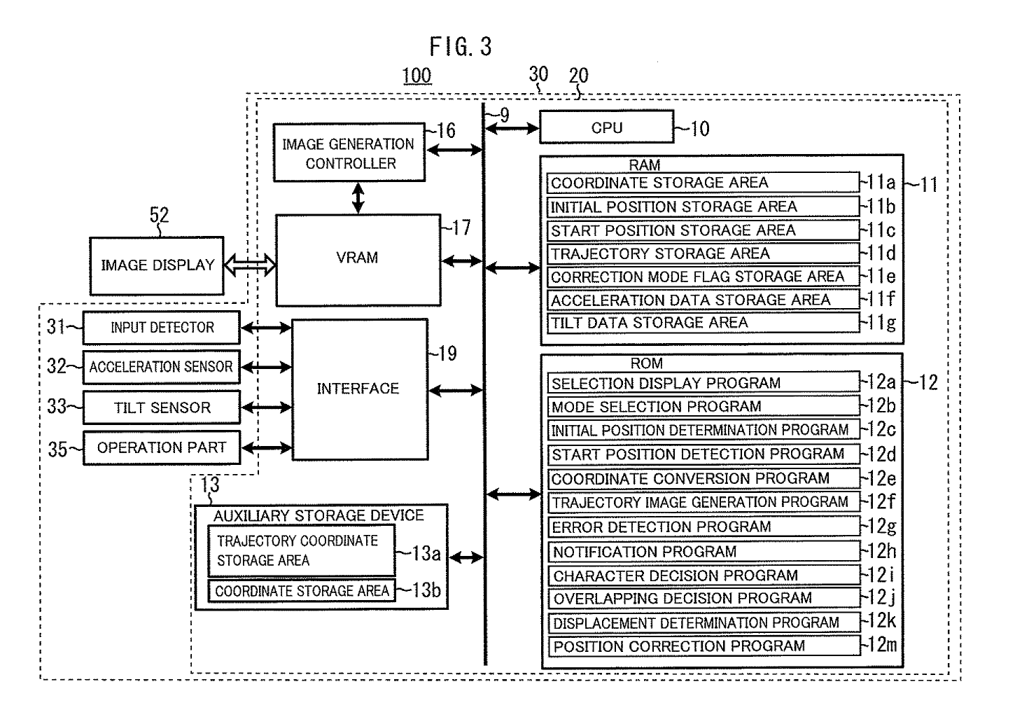

A description will be given of the block diagram of a head-mounted display 100 with reference to FIG. 3. The control part 30 includes a control board 20 that conducts a variety of types of control on the head-mounted display 100. The control board 20 is mounted thereon with a CPU 10, an RAM 11, an ROM 12, an auxiliary storage device 13, an image generation controller 16, a VRAM 17, and an interface 19. Those devices are interconnected through a bus 9. The image generation controller 16 and the VRAM 17 are connected to each other.

The CPU 10 is configured to perform a variety of operations and processing in cooperation with the RAM 11 and the ROM 12.

The RAM 11 is operative to temporarily store in its address space a program which is processed by the CPU 10 and data which is processed by the CPU 10. The RAM 11 has a coordinate storage area 11a, an initial position storage area 11b, a start position storage area 11c, a trajectory storage area 11d, a correction mode flag storage area 11e, an acceleration data storage area 11f, and a tilt data storage area 11g.

The coordinate storage area 11a stores “coordinates of input” provided to the bus 9.

In the initial position storage area 11b, “initial position coordinates” are stored which are in the display area 90 of the image display 52 and determined by an initial position determination program 12c to be described later.

In the start position storage area 11c, “start position coordinates” are stored, which are the coordinates of a position where the user starts to write/draw into the detection area 31a by using the pen 60.

In the trajectory storage area 11d, “trajectory coordinates” are stored which are generated by a coordinate conversion program 12e.

In the correction mode flag storage area 11e, a flag is stored which indicates either a “vertical correction mode” or a “horizontal correction mode”. It is to be noted that in the “vertical correction mode”, the displacement of characters will be corrected in the vertical direction (first direction). On the other hand, in the “horizontal correction mode”, the displacement of characters will be corrected in the horizontal direction (second direction).

It is to be noted that those first and second directions are perpendicular to each other.

In the acceleration data storage area 11f, “acceleration data” in the control part 30 (detection area 31a) and “detection time” of the “acceleration data” are stored.

In the tilt data storage area 11g, “tilt data” in the detection area 31a and “detection time” of the “tilt data” are stored.

In the ROM 12, a variety of programs and parameters which control the head-mounted display 100 are stored. Those various programs will be processed by the CPU 10 to realize the various functions. The ROM 12 stores a selection display program 12a, a mode selection program 12b, the initial position determination program 12c, a start position detection program 12d, the coordinate conversion program 12e, a trajectory image generation program 12f, an error detection program 12g, a notification program 12h, a character decision program 12i, an overlapping decision program 12j, a displacement determination program 12k, and a position correction program 12m. It is to be noted that those programs and data might as well be stored in the auxiliary storage device 13.

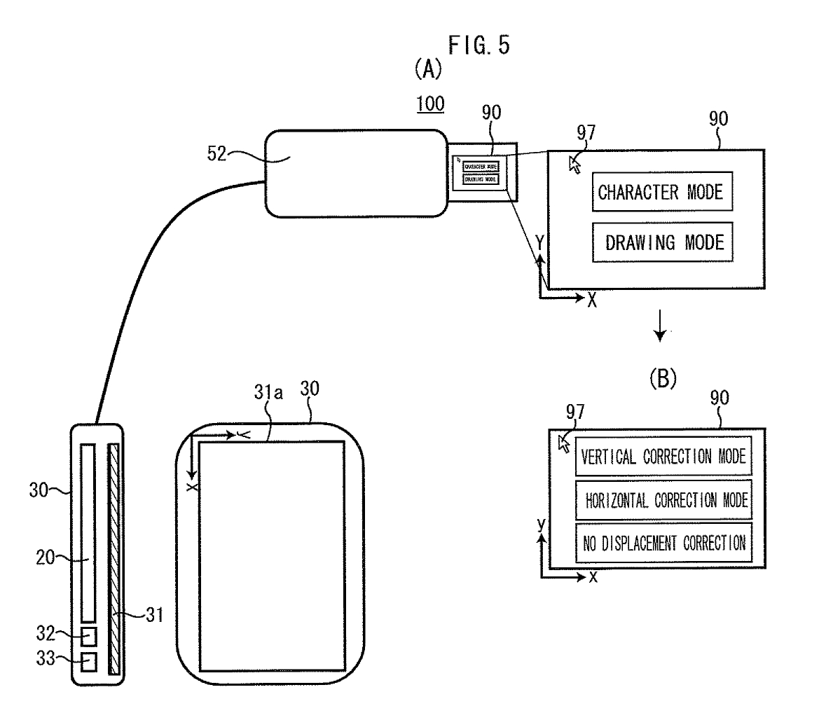

The selection display program 12a provides the image generation controller 16 with instructions that cause the display area 90 of the image display 52 to display therein a “mode selection screen” (see FIG. 5 (A)) on which either a “character mode” or a “drawing mode” is to be selected or a “correction mode selection screen” (see FIG. 5 (B)) on which either a “vertical correction mode” or a “horizontal correction mode” or “no displacement correction” is to be selected.

The mode selection program 12b decides which one of the “character mode” or the “drawing mode” is selected through selection by the user. Further, the mode selection program 12b decides which one of the “vertical correction mode”, the “horizontal correction mode”, and the “no displacement correction” is selected through selection by the user.

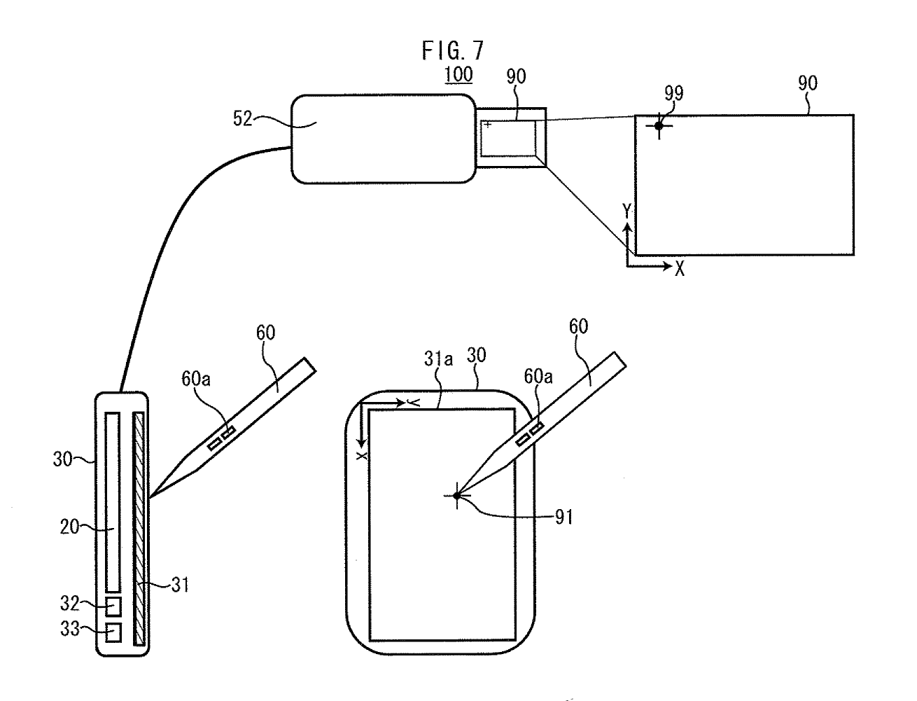

The initial position determination program 12c determines initial position coordinates 99 (see FIGS. 7 to 11) in the display area 90 of the image display 52.

The start position detection program 12d detects start position coordinates 91 (see FIGS. 7 to 11) where the user starts input, with respect to “coordinates of input”.

The coordinate conversion program 12e converts the start position coordinates 91 of the input by the user into the initial position coordinates 99 in the display area 90 of the image display 52 and sequentially calculates “trajectory coordinates” by using the initial position coordinates 99 and a positional relationship between the “coordinates of input” and the start position coordinates 91.

The trajectory image generation program 12f generates a “trajectory image” to be output to the image display 52, based on the aforementioned calculated “trajectory coordinates”.

The error detection program 12g detects that the input by the user comes close to or beyond an edge of the detection area 31a.

The notification program 12h gives the user a notification by causing the image display 52 to display a notification image when the input by the user comes close to or beyond the edge of the detection area 31a is detected.

The character decision program 12i decides whether or not one character is written completely through a writing by the user into the detection area 31a.

the overlapping decision program 12j detects overlapping of the neighboring characters written into the detection area 31a.

The displacement determination program 12k determines a relative displacement of characters written into the detection area 31a, with respect to their respective coordinates in the detection area 31a.

The position correction program 12m corrects a displacement of the neighboring characters based on their relative displacements.

It is to be noted that those programs might as well be realized in an ASIC.

The auxiliary storage device 13 is constituted of, for example, a nonvolatile memory or a hard disk. The auxiliary storage device 13 has a trajectory coordinate storage area 13a and a coordinate storage area 13b. The trajectory coordinate storage area 13a stores “trajectory coordinates” generated by a user into the detection area 31a, in the case of the “character mode”. The coordinate storage area 13b stores “coordinates of input” generated by a user into the detection area 31a, in the case of the “drawing mode”.

The image generation controller 16 has a GPU. The image generation controller 16 generates a “trajectory image” in response to a drawing instruction from the trajectory image generation program 12f and stores it in the VRAM 17. The “trajectory image” stored in the VRAM 17 is output as an image signal to the image display 52.

The interface 19 is operative to convert a physical and logical format of the signal. To the interface 19, the input detector 31, an acceleration sensor 32, a tilt sensor 33, and the operation part 35.

In the present embodiment, the pen 60 emits an alternating magnetic field from its tip. The input detector 31 is equipped with a matrix-shaped detection coil that detects the alternating magnetic field. In this configuration, “coordinates of input” are generated which are coordinates written/drawn by a user into the two-dimensional detection area 31a of the input detector 31. The “coordinates of input” are generated every predetermined lapse of time (several milliseconds). However, no “coordinates of input” will be generated when the user separated the pen 60 from the detection area 31a of the input detector 31. The generated “coordinates of input” are output to the bus 9 via the interface 19. The “coordinates of input” input to the bus 9 are stored in the coordinate storage area 11a of the RAM 11 together with a “detection time” when the “coordinates of input 2 were generated.

The acceleration sensor 32 is a device configured to detect an acceleration received by the detection area 31a. In the present embodiment, the acceleration sensor 32 detects an x-axial acceleration and y-axial acceleration of the absolute coordinate system of the detection area 31a. The acceleration sensor 32 detects the accelerations received by the detection area 31a and generates “acceleration data” every predetermined lapse of time (several milliseconds). The generated “acceleration data” is output to the bus 9 via the interfaced 19 and then stored in the acceleration data storage area 11f of the RAM 11 together with a “detection time” of this acceleration data.

The tilt sensor 33 is a device configured to detect a tilt of the detection area 31a with respect to the horizontal or vertical line. It is to be noted that in the present embodiment, for example, the vertical line may be a line along which the gravity acts on objects and the horizontal line, a line that is perpendicular to this vertical line. The tilt of the detection area 31a is detected by the tilt sensor 33 every predetermined lapse of time (several milliseconds), to generate “tilt data”. The generated “tilt data” is output to the bus 9 via the interface 19 and then stored in the tilt data storage area 11g of the RAM 11 together with a “detection time” of this tilt data.

The operation part 35 is constituted of a button or a touch panel. The operation part 35 is operated by the user, to turn the head-mounted display 100 on (power-applied state) or off (power-disrupted state) so that the head-mounted display 100 may be manipulated variously.

### (Explanation of Main Processing)

Although the following flow will be described on the assumption that the programs may be the subject thereof for ease of explanation, the real subject is the CPU 10, which realizes the various functions by executing those programs.

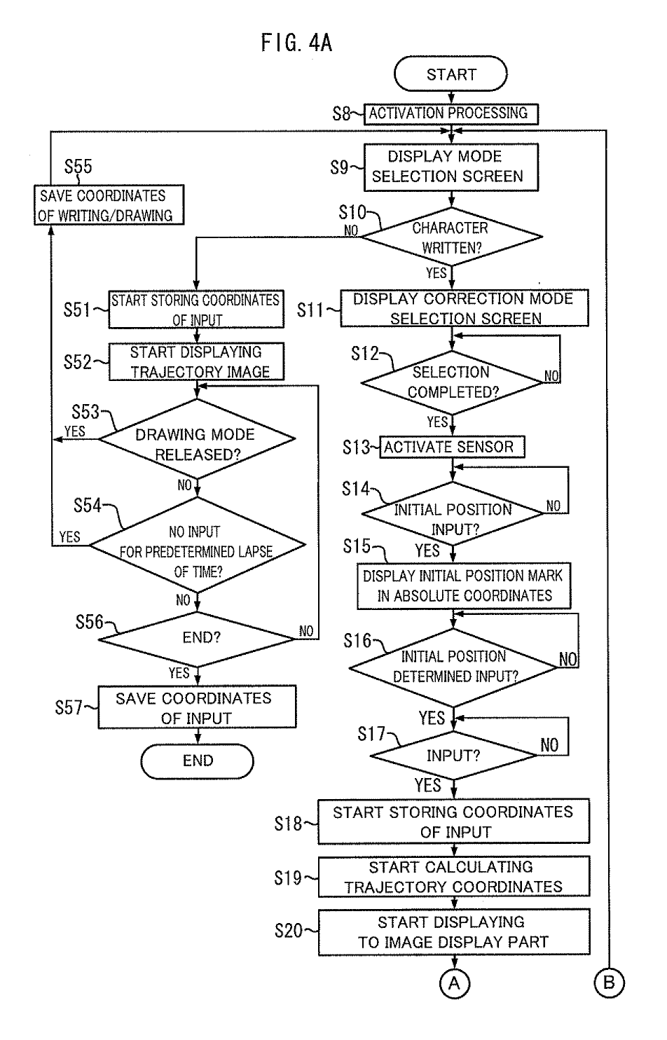

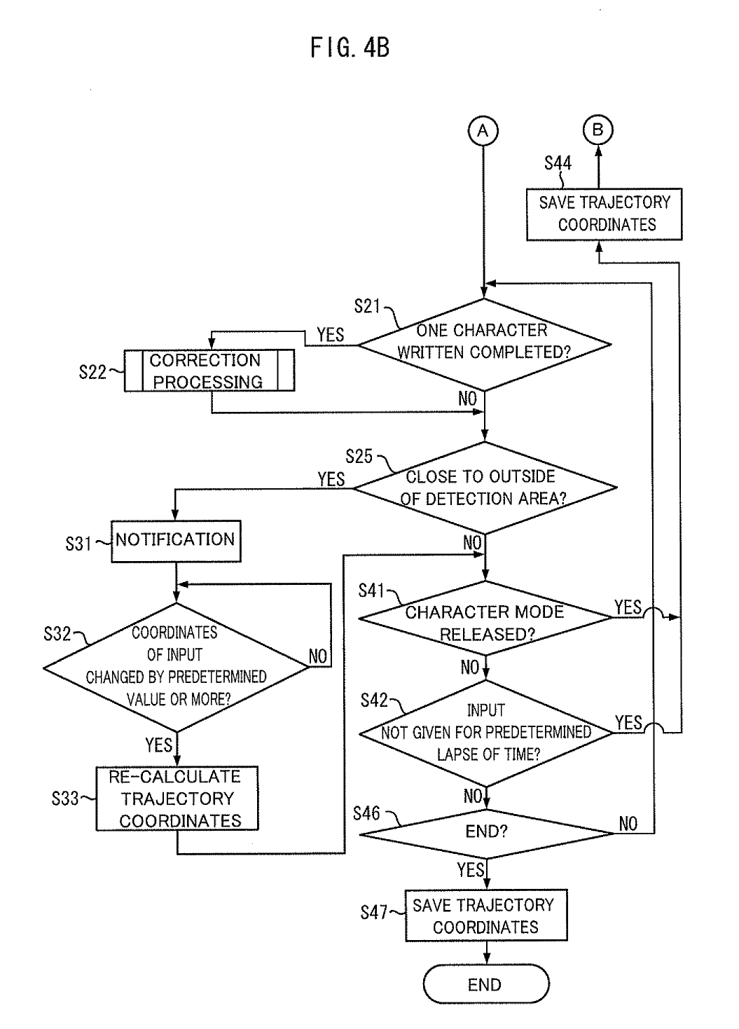

A description will be given of a main flow with reference to FIG. 4. When power is applied to the head-mounted display 100 through user manipulation on the operation part 35, main processing starts to make advances to processing in S8.

In S8, the various programs for the head-mounted display 100 are activated. When the processing in S8 ends, advances are made to processing in S9.

In S9, the selection display program 12a provides the image generation controller 16 with an instruction that causes the image display 52 to display the “mode selection screen” on which to select either the “character mode” or the “drawing mode”. Then, as shown in FIG. 5 (A), on the image display 52, the “mode selection screen” appears which includes a “character mode” button and a “drawing mode” button. Further, the mode selection program 12b provides the image generation controller 16 with an instruction to display the pointer 97 in the display area 90 of the image display 52. Then, as shown in FIG. 5 (A), the pointer 97 appears in the display area 90 of the image display 52. It is to be noted that when “dragging” is performed by the user to move the tip of the pen 60 to a predetermined position in the detection area 31a of the input detector 31 as held down there in a condition where the pointer 97 is displayed in the display area 90 of the image display 52, the pointer 97 moves accompanying this “dragging”. When the processing in S9 ends, advances are made to decision processing in S10.

In the decision processing in S10 the mode selection program 12b decides whether or not the “character mode” is selected through a user operation of the pen 60. When the “selection” is performed after the pointer 97 is moved to the “character mode” button through the user operation of the pen 60, the mode selection program 12b decides that the “character mode” is selected (YES in S10), making advances to processing in S11.

On the other hand, when the “selection” is performed after the pointer 97 is moved to the “drawing mode” button through the user operation of the pen 60, the mode selection program 12b decides that the “drawing mode” is selected (NO in S10), making advances to processing in S51.

It is to be noted that the “selection” includes, for example, a double click by which the user separates the tip of the pen 60 from the surface of the detection area 31a and then applies it thereto two times. Alternatively, the CPU 10 may decide the input to the operation part 35 in the decision processing in S10.

In the processing in S11, the selection display program 12a provides the image generation controller 16 with an instruction to display on the image display 52 a “correction mode selection screen” on which to select the “vertical correction mode”, the “horizontal correction mode”, or the “no displacement correction”. Then, as shown in FIG. 5 (B), on the image display 52, the correction mode selection screen appears which includes a “vertical correction mode” button, a “horizontal correction mode” button and a “no displacement correction” button. Further, the mode selection program 12b provides the image generation controller 16 with an instruction to display the pointer 97 in the display area 90 of the image display 52. Then, as shown in FIG. 5 (B), the pointer 97 appears in the display area 90 of the image display 52. When the processing in S11 ends, advances are made to decision processing in S12.

In the decision processing in S12, the mode selection program 12b decides which one of the “vertical correction mode”, the “horizontal correction mode”, and the “no displacement correction” is selected by the user with the pen 60. When the selection is performed after the pointer 97 is moved by the user with the pen 60 to the button of any one of the “vertical correction mode”, the “horizontal correction mode”, and the “no displacement correction”, the mode selection program 12b stores this selected mode in the correction mode flag storage area 11e (YES in S12), making advances to decision processing in S13.

On the other hand, when none of the “vertical correction mode”, the “horizontal correction mode”, and the “no displacement correction” is selected (NO in S12), no advances are made to the selection processing in S13.

In the processing in S13, the CPU 10 causes the acceleration sensor 32 to start detecting an acceleration of the detection area 31a. “Acceleration data” detected and generated by the acceleration sensor 32 is stored in the acceleration data storage area 11f of the RAM 11 together with a “detection time”.

Further, the CPU 10 causes the tilt sensor 33 to start detecting a tilt of the detection area 31a. “Tilt data” detected and generated by the tilt sensor 33 is stored in the tilt data storage area 11g of the RAM 11 together with a “detection time”.

When the processing in S13 ends, advances are made to decision processing in S14.

In the decision processing in S14, the initial position determination program 12c decides whether or not an initial position is input. Specifically, when the user touches the detection area 31a of the input detector 31 with the tip of the pen 60, the initial position determination program 12c decides that an initial position is input (YES in S14), making advances to processing in S15. On the other hand, when the initial position determination program 12c does not decide that an initial position is input (NO in S14), no advances are made to the processing in S15.

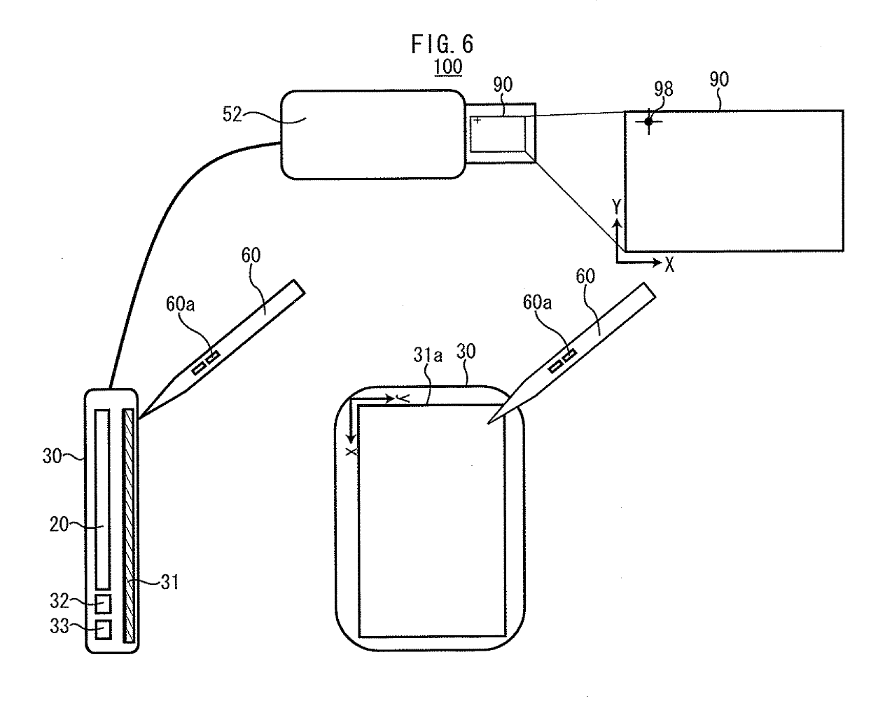

In the processing in S15, the initial position determination program 12c provides the image generation controller 16 with an instruction to display an initial position mark 98 at such a position in the display area 90 as to correspond to the absolute coordinates of the tip of the pen 60 in the detection area 31a that are detected in the processing in S14. Then, as shown in FIG. 6, the initial position mark 98 appears in the display area 90 of the image display 52. When the processing in S15 ends, advances are made to processing in S16.

In the decision processing in S16, the initial position determination program 12c decides whether or not an initial position determination is input. Specifically, when the initial position determination program 12c decides that the initial position determination is input by a user on the operation part 35 (YES in S16), the initial position determination program 12c stores the coordinates in the display area 90 of the image display 52 at which the initial position mark 98 is displayed in the initial position storage area 11b of the RAM 11 as “initial position coordinates”, making advances to decision processing in S17. On the other hand, when the initial position determination program 12c does not decide that the initial position determination is input (NO in S16), no advances are made to the decision processing in S17. In such a manner, the present invention enables the user to select an arbitrary position in the display area 90 of the image display 52 as the “initial position coordinates”.

In the decision processing in S17, the CPU 10 decides whether or not input is performed by the user. Specifically, when the CPU 10 decides that “coordinates of input” are input to the bus 9 via the interface 19 by a user into the detection area 31a of the input detector 31 by use of the pen 60 (YES in S17), advances are made to processing in S18. In this case, the start position detection program 12d stores the time-series-based least recent “coordinates of input” as “start position coordinates” in the start position storage area 11c of the RAM 11. On the other hand, when the CPU 10 does not decide that the “coordinates of input” are input to the bus 9 via the interface 19 (NO in S17), no advances are made to the processing in S18.

In the processing in S18, the CPU 10 starts processing to store the “coordinates of input” input to the bus in the coordinate storage area 11a of the RAM 11. When the processing in S18 ends, advances are made to processing in S19.

In the processing in S19, the coordinate conversion program 12e starts calculating “trajectory coordinates” of a trajectory of input by the user that are to be displayed in the display area 90 of the image display 52. The following will describe the processing of the coordinate conversion program 12e calculating the “trajectory coordinates”.

The coordinate conversion program 12e recognizes “initial position coordinates” and “start position coordinates” by referencing the initial position storage area 11b and the start position storage area 11c of the RAM 12 respectively. Then, as shown in FIG. 7, the coordinate conversion program 12e converts the start position coordinates 91 of the input by the user into the initial position coordinates 99 in the display area 90 of the image display 52.

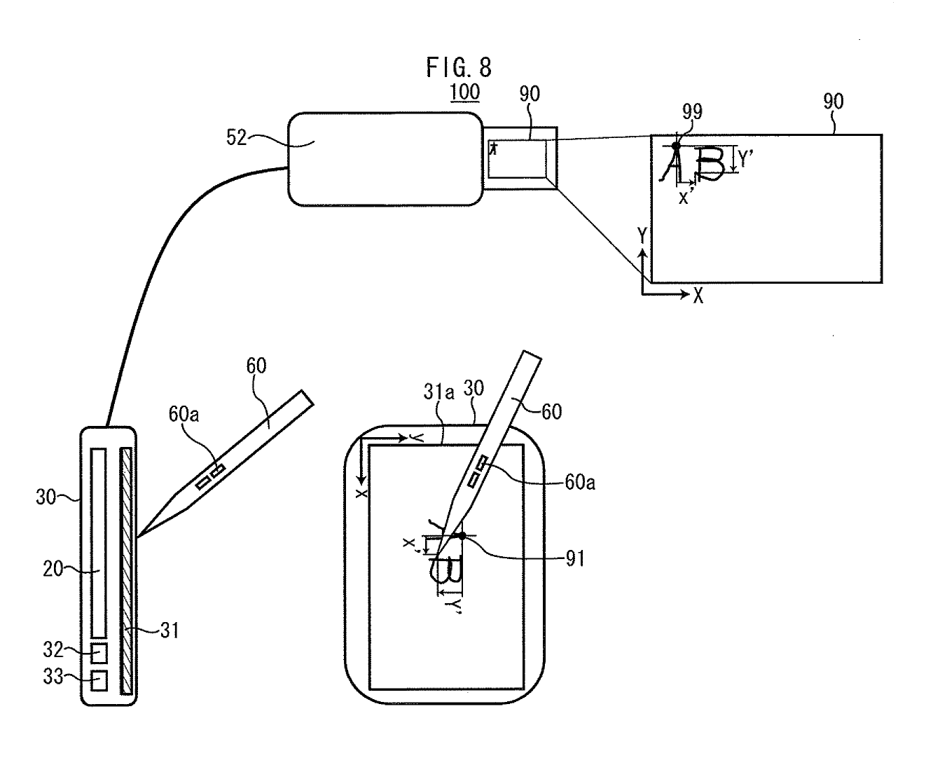

Next, the coordinate conversion program 12e recognizes the “coordinates of input” by referencing the coordinate storage area 11a of the RAM 11. Then, the coordinate conversion program 12e sequentially calculates “trajectory coordinates” by using the initial position coordinates 99 and a positional relationship between the “coordinates of input” and the start position coordinates 91. In the present embodiment, the coordinate conversion program 12e sequentially calculates the “trajectory coordinates” by adding a different value (X′, Y′ shown in FIG. 8) between the “coordinates of input” and the start position coordinates 91 to the initial position coordinates 99. The calculated “trajectory coordinates” are stored in the trajectory storage area 11d of the RAM 11.

When the processing in S19 ends, advances are made to processing in S20.

In the processing in S20, the trajectory image generation program 12f generates a “display area trajectory image” based on the “trajectory coordinates” stored in the trajectory storage area 11d. Specifically, the trajectory image generation program 12f provides the image generation controller 16 with a drawing instruction to generate a line which interconnects the time-series-based neighboring “trajectory coordinates” with each other. However, when the time-series-based neighboring “trajectory coordinates” are separated from each other by at least a predetermined distance, the time-series-based neighboring “trajectory coordinates” are not interconnected with each other because the user has the pen 60 put away from the detection area 31a of the input detector 31.

When the drawing instruction to generate the line interconnecting the time-series-based neighboring “trajectory coordinates” is input to the image generation controller 16, a “display area trajectory image” constituted of a character string appears in the display area 90 of the image display 52 as shown in FIG. 8. When the processing in S20 ends, advances are made to decision processing in S21.

In the decision processing in S21, character decision program 12i decides whether or not the user has finished writing one character. Specifically, the character decision program 12i decides whether or not each of the “detection time” of the time-series-based neighboring “trajectory coordinates” is separated from each other by at least a predetermined lapse of time (for example, several 100 milliseconds) by referencing the coordinate storage area 11a and, when each of the “detection time” is separated from each other by at least the predetermined lapse of time, decides that one character has been written by the user into the detection area 31a. When the character decision program 12i decides that the user has written one character (YES in S21), advances are made to processing in S22. On the other hand, when the character decision program 12i decides that the user is yet to write one character (NO in S21), advances are made to decision processing in S25.

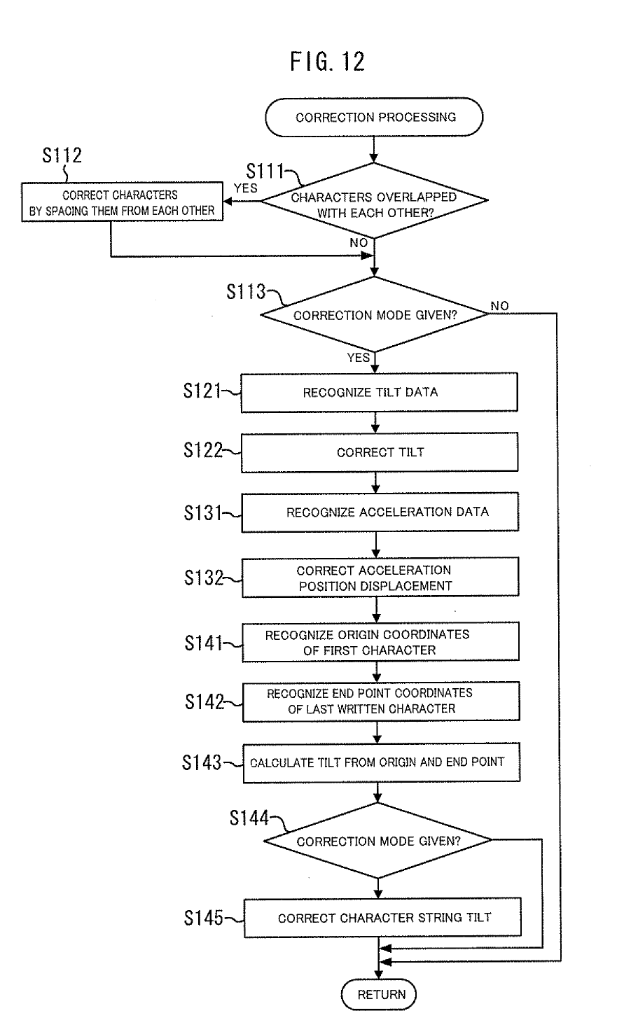

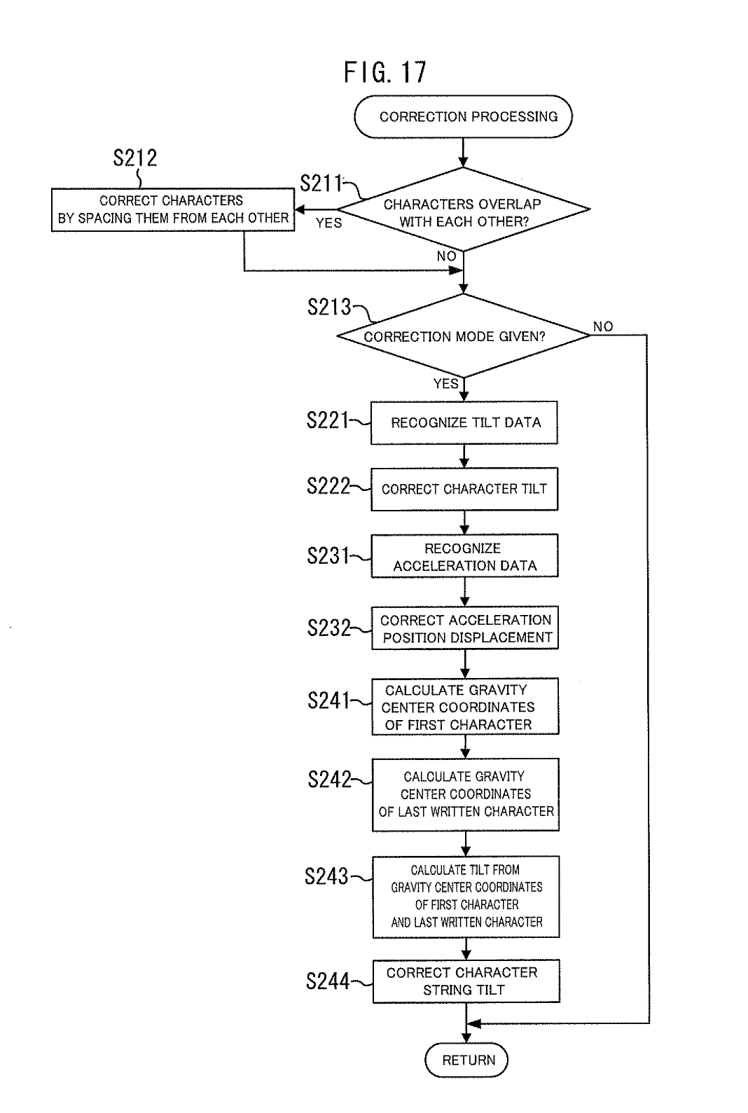

In S22, “correction processing” is performed on the characters written in the detection area 31a to correct their displacements, tilts, and overlaps. It will be described in more detail with reference to a flow shown in FIG. 12 or 17. When the processing in S22 ends, advances are made to the decision processing in S25.

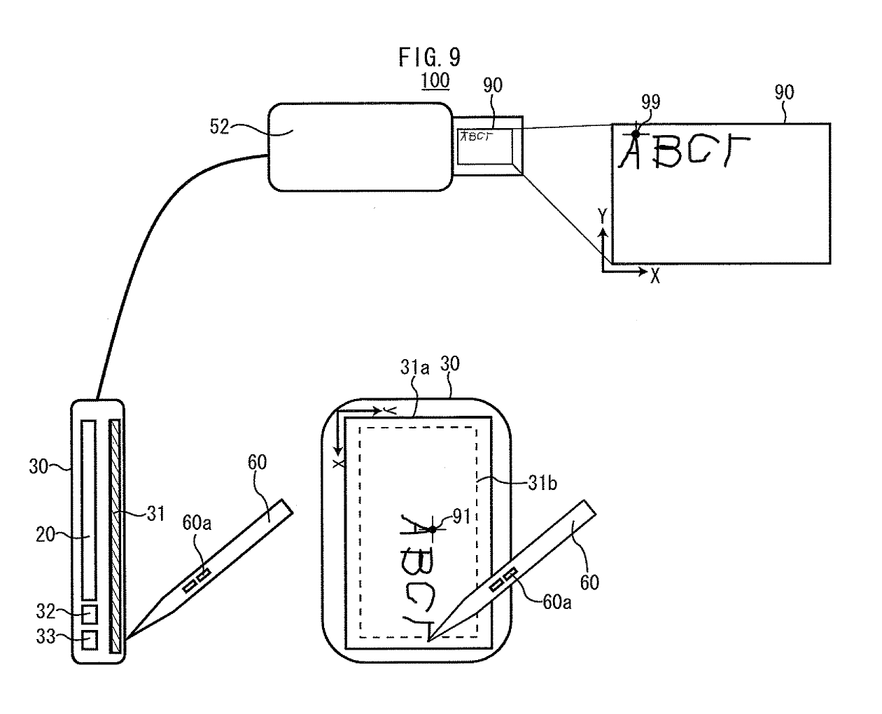

In the decision processing in S25, the error detection program 12g decides whether or not the input by the user (tip of the pen 60) comes close to or beyond the edge of the detection area 31a is detected. It is to be noted that as shown in FIG. 9, the input detector 31 has a close notification area 31b that covers from the outer edge of the detection area 31a to a slightly inward line therefrom. With this, when the input by the user enters the close notification area 31b, the error detection program 12g decides that the input by the user has come close to the outside of the detection area 31a. Further, when input by the user is yet to be detected in the detection area 31a after this input entered the close notification area 31b, the error detection program 12g decides this the input has been beyond the edge of the detection area 31a.

When the error detection program 12g detects that the input came close to or beyond the edge of the detection area 31a (YES in S25), advances are made to processing in S31.

On the other hand, when the error detection program 12g does not detect that the input came close to or beyond the edge of the detection area 31a (NO in S25), advances are made to processing in S41.

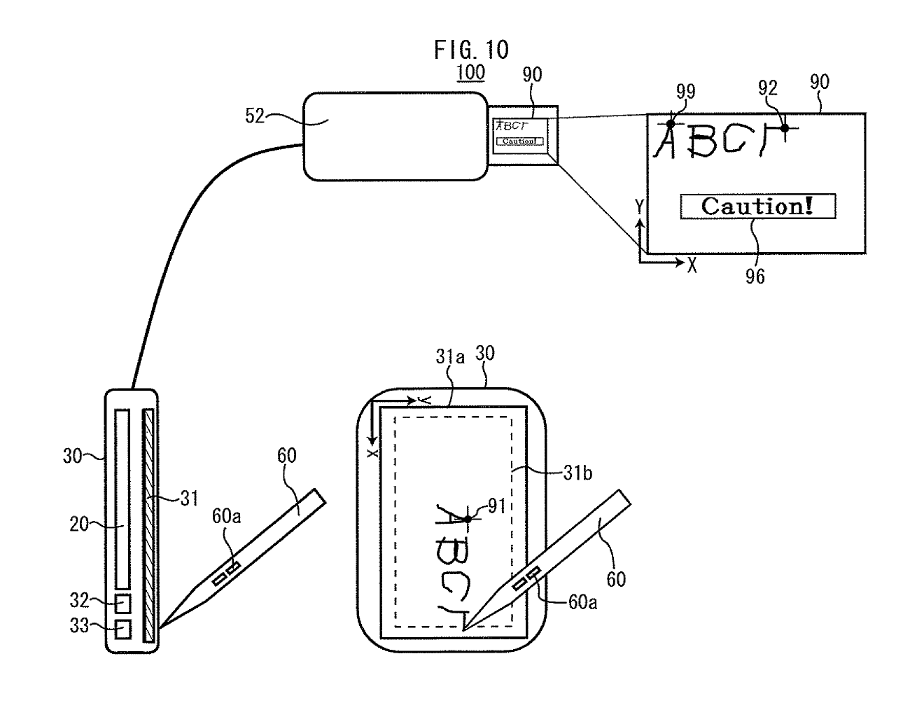

In the processing in S31, the notification program 12h provides the image generation controller 16 with a drawing instruction that causes the image display 52 to display a notification screen thereon. Then, a notification appears on the image display 52 as shown in FIG. 10.

An alternative embodiment may be such that the head-mounted display 100 would be equipped with a speaker to reproduce a notification sound therefrom so that the user might be notified.

When the processing in S31 ends, advances are made to decision processing in S32.

In the decision processing in S32, the error detection program 12g decides whether or not the “coordinates of input” have changed at least a predetermined value by referencing the coordinate storage area 11a of the RAM 11. That is, when the user moves the pen 60 to the inside of the detection area 31a because s/he knows a notification in the processing in S31, the “coordinates of input” change at least the predetermined value. When the error detection program 12g decides that the “coordinates of input” have changed by at least the predetermined value (YES in S32), advances are made to processing in S33. On the other hand, when the error detection program 12g does not decide that the “coordinates of input” have changed by at least the predetermined value (NO in S32), no advances are made to processing in S33.

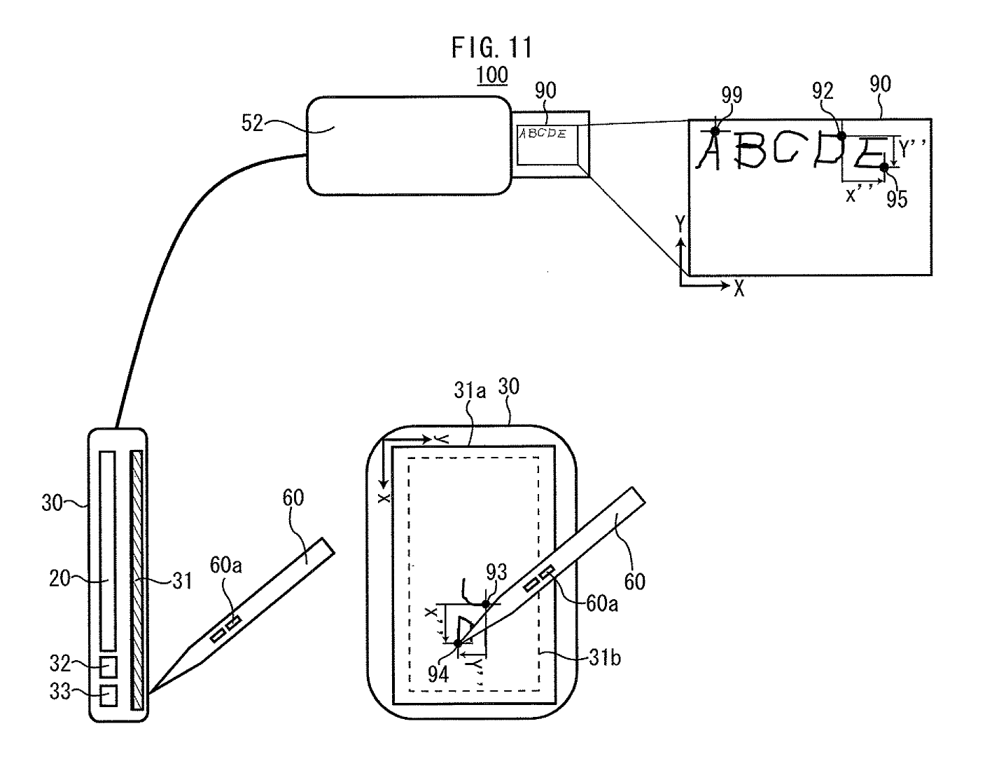

In the processing in S33, the coordinate conversion program 12e calculates the trajectory coordinates 95 (see FIG. 11) by using the trajectory coordinates 92 (see FIGS. 10 and 11) at a point in time when the error detection program 12g detected that the input came close to or beyond the edge of the detection area in the decision processing in S25 and a positional relationship between the start position coordinates 93 and the coordinates of input 94 (see FIG. 11) after the input detector 31 detected the input again. In the present embodiment, the coordinate conversion program 12e calculates the trajectory coordinates 95 by adding the different value (X″, Y″ shown in FIG. 11) between the aforementioned coordinates of input 94 and start position coordinates 93 to the aforesaid trajectory coordinates 92. The calculated “trajectory coordinates” are stored in the trajectory storage area 11d of the RAM 11. Further, as shown in FIG. 11, based on the re-calculated “trajectory coordinates”, a “display area trajectory image” appears in the display area 90 of the image display 52.

In such a manner, when the pen 60 was once about to depart from the detection area 31a and then moved back to the inside of the detection area 31a by the user, the “trajectory coordinates” are re-calculated in the processing in S33 and so will be calculated continually, thereby displaying the “display area trajectory image” in the display area 90 of the image display 52. When the processing in S33 ends, advances are made to decision processing in S41.

In the decision processing in S41, the CPU 10 decides whether or not a signal that releases the “character mode” is input to the bus 9 through user manipulation of the operation part 35. When the CPU 10 decides that the signal releasing the “character mode” is input to the bus 9 (YES in S41), advances are made to processing in S44. On the other hand, when the CPU 10 decides that the signal releasing the “character mode” is yet to be input to the bus 9 (NO in S41), advances are made to decision processing in S42.

In the decision processing in S42, the CPU 10 decides whether or not no input has been given into the detection area 31a of the input detector 31 for at least a predetermined lapse of time (for example, several minutes). Specifically, when the CPU 10 decides that no “coordinates of input” are input to the bus 9 for at least the predetermined lapse of time (YES in S42), advances are made to processing in S44. On the other hand, when the CPU 10 decides that “coordinates of input” are input to the bus 9 (NO in S42), advances are made to processing in S46.

In the processing in S44, the CPU 10 saves the “trajectory coordinates” stored in the trajectory storage area 11d of the RAM 11 into the trajectory storage area 13a of the auxiliary storage device 13. In such a manner, by saving the “trajectory coordinates” in the trajectory storage area 13a, it is possible to utilize the contents of the input afterward. When the processing in S44 ends, a return is made to the processing in S9.

In the decision processing in S46, the CPU 10 decides whether or not an “end signal” is input to the bus 9 through user manipulation of the operation part 35. When the CPU 10 decides that the end signal is input to the bus 9 (YES in S46), advances are made to processing in S47. When the CPU 10 decides that the “end signal” is yet to be input to the bus 9 (NO in S46), a return is made to the processing in S25.

In the processing in S47, the CPU 10 saves the “trajectory coordinates” stored in the trajectory storage area 11d of the RAM 11 into the trajectory storage area 13a of the auxiliary storage device 13. When the processing in S47 ends, the head-mounted display 100 is turned off, to end the series of flows.

In the processing in S51, the CPU 10 causes the coordinate storage area 11a of the RAM 11 to start processing to store the “coordinates of input” input to the bus. When the processing in S51 ends, advances are made to processing in S52.

In the processing in S52, the trajectory image generation program 12f generates the “display area trajectory image” based on the “coordinates of input” stored in the coordinate storage area 11a of the RAM 11. Specifically, the trajectory image generation program 12f provides the image generation controller 16 with a drawing instruction to generate a line which interconnects the time-series-based neighboring “coordinates of input” with each other. However, when the time-series-based neighboring “coordinates of input” are separated from each other by at least a predetermined distance, the time-series-based neighboring “coordinates of input” are not interconnected with each other because it is considered that the user has the pen 60 put away from the detection area 31a of the input detector 31. When the image generation controller 16 is provided with the drawing instruction to interconnect the time-series-based neighboring “coordinates of input” with each other, a “display area trajectory image” appears in the display area 90 of the image display 52. That is, when the input mode is the “drawing mode”, contents which are entered by the user into the detection area 31a by using the pen 60 are directly displayed in the display area 90 of the image display 52. When the processing in S52 ends, advances are made to processing in S53.

In the decision processing in S53, the CPU 10 decides whether or not a signal that releases the “drawing mode” is input to the bus 9 through user manipulation of the operation part 35. When the CPU 10 decides that the signal that releases the “drawing mode” is input to the bus 9 (YES in S53), advances are made to processing in S55. On the other hand, when the CPU 10 decides that the signal that releases the drawing mode is yet to be input to the bus 9 (NO in S53), advances are made to decision processing in S54.

In the decision processing in S54, the CPU 10 decides whether or not input has not been given into the detection area 31a of the input detector 31 for at least a predetermined lapse of time (for example, several minutes). Specifically, when the CPU 10 decides that no “coordinates of input” have been input to the bus 9 (YES in S54), advances are made to the processing in S55. On the other hand, when the CPU 10 decides that “coordinates of input” have been provided to the bus 9 within the predetermined lapse of time (NO in S54), advances are made to decision processing in S56.

In the processing in S55, the CPU 10 saves the “coordinates of input” stored in the coordinate storage area 11a of the RAM 11 into the coordinate storage area 13b of the auxiliary storage device 13. When the processing in S55 ends, a return is made to the processing in S9.

In the decision processing in S56, the CPU 10 decides whether or not the “end signal” is input to the bus 9 through user manipulation of the operation part 35. When the CPU 10 decides that the “end signal” is input to the bus 9 (YES in S56), advances are made to the processing in S47. When the CPU 10 decides that the “end signal” is yet to be input to the bus 9 (NO in S56), a return is made to the decision processing in S53.

In the processing in S57, the CPU 10 saves the “coordinates of input” stored in the trajectory coordinate storage area 11a of the RAM 11 into the coordinate storage area 13b of the auxiliary storage device 13. When the processing in S57 ends, the head-mounted display 100 is turned off, to end the series of flows.

It is to be noted that although this embodiment has displayed on the image display 52 a trajectory of the input which were in the middle of entry into the detection area 31a in the processing in S20, an alternative embodiment may be such that when the processing in S22 ends upon completion of one character after skipping the processing in S20, characters that constitute the trajectory of those input may appear on the image display 52.

### (Correction Processing in First Embodiment)

A description will be given of the “correction processing” in the first embodiment with reference to FIGS. 12 to 16. When the “correction processing” starts, advances are made to processing in S111.

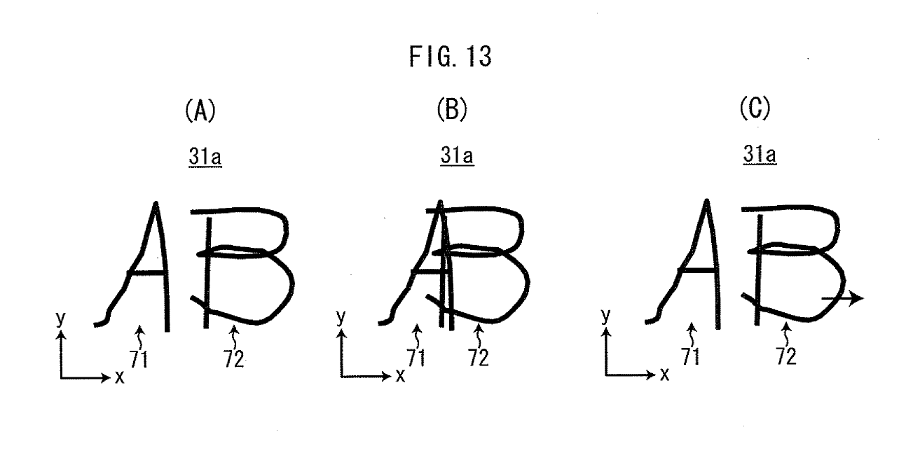

In the decision processing in S111, the overlapping decision program 12j decides whether or not a newly written character 72 overlaps with a previously written character 71 as shown in FIGS. 13 (A) and (B). Specifically, the overlapping decision program 12j decides whether or not a line (trajectory) interconnecting the “trajectory coordinates” of the previously written character 71 intersects with a line (trajectory) interconnecting the “trajectory coordinates” of the newly written character 72 by referencing the trajectory storage area 11d of the RAM 11, thereby deciding whether or not the newly written character 72 overlaps with the previously written character 71. When the overlapping decision program 12j decides that the newly written character 72 overlaps with the previously written character 71 (in the state of FIG. 13 (B)) (YES in S111), advances are made to processing in S112. On the other hand, when the overlapping decision program 12j decides that the newly written character 72 does not overlap with the previously written character 71 (in the state of FIG. 13 (A)) (NO in S111), advances are made to decision processing in S113.

In the processing in S112, the position correction program 12m recognizes the “trajectory coordinates” by referencing the trajectory storage area 11d. Then, the displacement determination program 12k calculates a displacement over which the previously written character 71 and the newly written character 72 that are adjacent to each other do not overlap, based on the recognized “trajectory coordinates”. The position correction program 12m changes the “trajectory coordinates” so that the newly written character 72 may move to a position where the previously written character 71 and the newly written character 72 adjacent to each other may not overlap with each other (see FIG. 13 (C)) based on this calculated displacement and stores the updated “trajectory coordinates” in the trajectory storage area 11d. When the processing in S112 ends, advances are made to decision processing in S113.

In the decision processing in S113, the CPU 10 decides whether or not either the “vertical correction mode” or the “horizontal correction mode” is selected, by referencing the correction mode flag storage area 11e of the RAM 11. When the CPU 10 decides that any one of the “vertical correction mode” and the “horizontal correction mode” is selected (YES in S113), advances are made to the processing in S111. On the other hand, when the CPU 10 decides that the “no displacement correction” is selected (NO in S113), S22 “correction processing” ends and advances are made to the decision processing in S25.

In the processing in S121, the displacement determination program 12k recognizes a tilt angle θ of the detection area 31a with respect to the horizontal line or the vertical line by referencing the tilt data storage area 11g of the RAM 11. In the embodiment shown in FIG. 14, the displacement determination program 12k recognizes the tilt angle θ of the detection area 31a with respect to the vertical line (X′-axis). When the processing in S121 ends, advances are made to processing in S122.

In the processing in S122, the position correction program 12m changes reference coordinates of the “trajectory coordinates” from the absolute coordinates (x, y) of the detection area 31a to the relative coordinates (x′, y′) obtained by rotating these absolute coordinates by the aforementioned tilt angle θ, to generate “trajectory coordinates” having those relative coordinates as the reference coordinates and store those updated “trajectory coordinates” in the coordinate storage area 11d. In this “character tilt correction processing”, the tilt of characters written to the absolute coordinates (x, y) of the detection area 31a will be corrected. When the processing in S122 ends, advances are made to processing in S131.

In the processing in S131, displacement determination program 12k recognizes an “acceleration” received by the detection area 31a and a “detection time” of this “acceleration” by referencing the acceleration data storage area 11f of the RAM 11. When the processing in S131 ends, advances are made to processing in S132.

In the processing in S132, the displacement determination program 12k cross-checks the “detection times” of the “accelerations” and “detection times” of the “trajectory coordinates” with each other and, based on the “acceleration” whose “detection times” agree, calculates a displacement of the “trajectory coordinates” that corresponds to this “detection time”. This displacement is calculated corresponding to the “acceleration”. Based on this calculated displacement of the “trajectory coordinates”, the position correction program 12m moves the “coordinates of input” to a side opposite to the direction of the corresponding “acceleration”, thereby generating “trajectory coordinates”. The generated “trajectory coordinates” is stored in the trajectory storage area 11d as updated coordinates.

For example, as shown in FIG. 15, when the user who uses the head-mounted display 100 while walking writes characters into the detection area 31a which moves back and forth and up and down, and even when the characters written into the detection area 31a are displaced from each other, this “acceleration displacement correction” corrects this displacement of those characters.

It is to be noted that although in the embodiment shown in FIG. 15, the position correction program 12m has corrected only the y-axial displacement of the “trajectory coordinates”, of course, the position correction program 12m corrects also the x-axial displacement of the “trajectory coordinates”.

When the processing in S132 ends, advances are made to processing in S141.

In the processing in S141, the displacement determination program 12k recognizes origin coordinates 75 of a first character 73 written into the detection area 31a by referencing the trajectory storage area 11d. Specifically, the displacement determination program 12k recognizes the “trajectory coordinates” having the least recent “detection time” time-series-based as the origin coordinates 75 of the first character 73. When the processing in S141 ends, advances are made to processing in S142.

In the processing in S142, the displacement determination program 12k recognizes end point coordinates 76 of the last character 74 written into the detection area 31a (most recently written character) by referencing the trajectory storage area 11d. Specifically, the displacement determination program 12k recognizes the “trajectory coordinates” having the time-series-based most recent “detection time” as the end point coordinates 76 of the last written character 74. When the processing in S142 ends, advances are made to processing in S143.

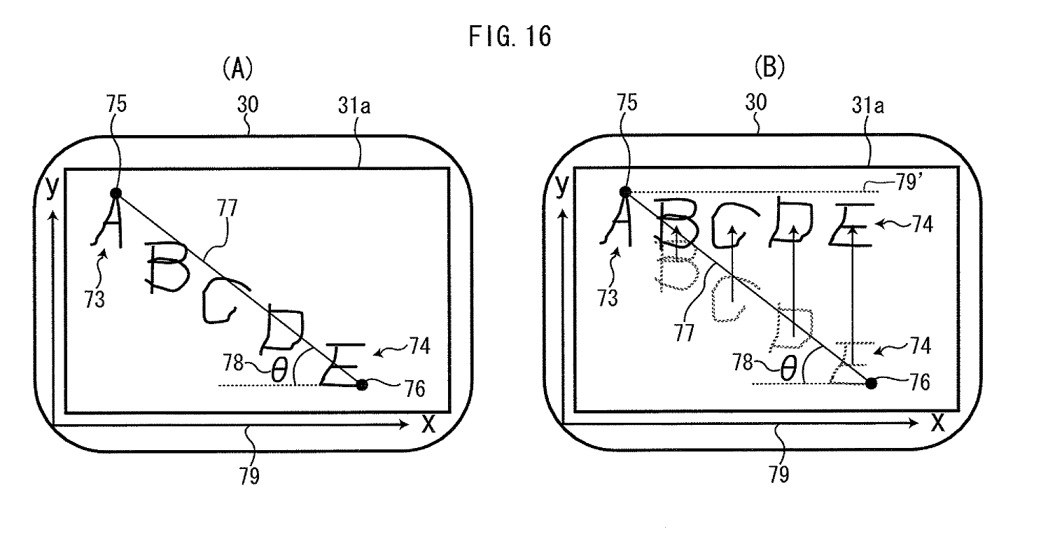

In the processing in S143, the displacement determination program 12k confirms which one of the “vertical correction mode” and the “horizontal correction mode” is selected as the current correction mode by referencing the correction mode flag storage area 11e. Then, the displacement determination program 12k calculates a tilt of a straight line 77 interconnecting the origin coordinates 75 of the first character 73 and the end point coordinates 76 of the last input character 74 that were recognized in the processing in S141 and that in S142 respectively, with respect to a reference line of the absolute coordinates (x, y) of the detection area 31a. When the correction mode is the “vertical correction mode”, the x-axis of the absolute coordinates of the detection area 31a provides the reference line 79 as shown in FIG. 16 (A). In this case, the displacement determination program 12k calculates a tilt angle θ 78 of the straight line 77 with respect to the x-axis, which is this reference line 79. On the other hand, when the correction mode is the “horizontal correction mode”, the y-axis of the absolute coordinates of the detection area 31a provides the reference line. In this case, the displacement determination program 12k calculates the tilt angle θ of the straight line 77 with respect to the y-axis, which is this reference line. When the processing in S143 ends, advances are made to decision processing in S144.

In the decision processing in S144, the CPU 10 decides whether or not the tilt (tilt angle θ) of the straight line 77 calculated in the processing in S143 with respect to the absolute coordinates (x, y) of the detection area 31a is at least a predetermined value. When the CPU 10 decides that the tilt with respect to the reference line is at least the predetermined value (YES in S144), advances are made to processing in S145. On the other hand, when the CPU 10 decides that the tilt of the straight line 77 with respect to the absolute coordinates (x, y) of the detection area 31a is smaller than the predetermined value (NO in S144), the “correction processing” ends and advances are made to the decision processing in S25.

In the processing in S145, the position correction program 12m corrects the “trajectory coordinates” so that the positional relationship between the first character 73 and the last input character 74 may be parallel to the reference line 79 (the x-axis is the reference line in the embodiment in FIG. 16) such as shown in FIG. 16 (B) based on the tilt (tilt angle θ 78) of the straight line 77 calculated in the processing in S143 with respect to the absolute coordinates (x, y) of the detection area 31a. Specifically, a reference line 79′ parallel to the reference line 79 is calculated by assuming that the origin coordinates 75 of the first character to be a starting point, and based on comparison between the reference line 79′ and the straight line 77, a y-axial movement distance is calculated corresponding to the x-coordinate of each of the characters whose straight line 77 is to be corrected to the reference line 79′. Then, each of the characters is corrected by adding this y-axial movement distance. The corrected “trajectory coordinates” are stored in the trajectory storage area 11d as updated coordinates. When the processing in S145 ends, the “correction processing” ends and advances are made to the decision processing in S25.

Since the different characters have different start positions and end positions, even if the neighboring characters are not tilted with respect to the absolute coordinates of the detection area 31a, the straight line 77 may be tilted with respect to the reference line of the absolute coordinates of the detection area 31a in some cases. In the decision processing in S144, when the tilt of the straight line 77 with respect to the reference line is smaller than the predetermined value, S145 “character string tilt correction” will not be performed, so that no “trajectory coordinates” will be corrected meaninglessly.

### (Correction Processing in Other Embodiments)

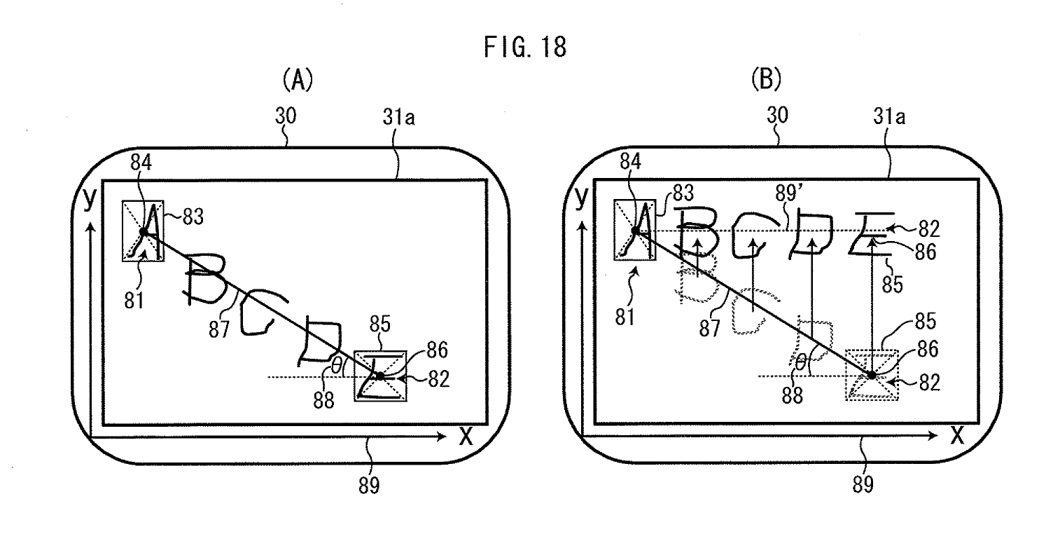

A description will be given of the “correction processing” in the other embodiments with reference to FIGS. 17 and 18. The processing in S211, S212, S213, S221, S222, S231, and S232 in the “correction processing” in a second embodiment are the same as the processing in S111, S112, S113, S121, S122, S131, and S132 of the “correction processing” in the first embodiment, and repetitive description on the identical processing pieces will be omitted.

When the processing in S232 ends, advances are made to processing in S241.

In the processing in S241, the displacement determination program 12k calculates gravity center coordinates 84 of the first character 81 written into the detection area 31a in the absolute coordinates (x, y) of the detection area 31a. Specifically, the displacement determination program 12k calculates this gravity center coordinates 84 by calculating the gravity center coordinates of a quadrilateral 83 that encloses this first character 81. When the processing in S241 ends, advances are made to processing in S242.

In the processing in S242, the displacement determination program 12k calculates gravity center coordinates 86 of the last character 82 written into the detection area 31a in the absolute coordinates (x, y) of the detection area 31a. Specifically, the displacement determination program 12k calculates this gravity center coordinates 86 by calculating the gravity center coordinates of a quadrilateral 85 that encloses this last written character 82. When the processing in S242 ends, advances are made to processing in S243.

In the processing in S243, the displacement determination program 12k confirms which one of the “vertical correction mode” and the “horizontal correction mode” is selected as the current correction mode by referencing the correction mode flag storage area 11e. Then, the displacement determination program 12k calculates a tilt of a straight line 87 interconnecting the gravity center coordinates 84 of the first character 81 and the gravity center coordinates 86 of the last written character 82 that were recognized in the processing in S241 and that in S242 respectively, with respect to the reference line of the absolute coordinates (x, y) of the detection area 31a. When the correction mode is the “vertical correction mode”, the x-axis of the absolute coordinates of the detection area 31a provides a reference line 89 as shown in FIG. 18 (A). In this case, the displacement determination program 12k calculates a tilt angle θ 88 of the straight line 87 with respect to the x-axis, which is this reference line 89. On the other hand, when the correction mode is the “horizontal correction mode”, the y-axis of the absolute coordinates of the detection area 31a provides the reference line. In this case, the displacement determination program 12k calculates a tilt angle θ of the straight line 87 with respect to the y-axis, which is this reference line. When the processing in S243 ends, advances are made to processing in S244.

In the processing in S244, the position correction program 12m corrects the “trajectory coordinates” so that the positional relationship between the first character 81 and the last written character 82 may be parallel to the reference line 89 (the X-axis is the reference line 89 in the embodiment in FIG. 18) such as shown in FIG. 18 (B) based on the tilt (tilt angle θ 78) of the straight line 87 calculated in the processing in S243 with respect to the absolute coordinates (x, y) of the detection area 31a. Specifically, a reference line 89′ parallel to the reference line 89 is calculated by assuming that the origin coordinates 84 of the first character to be a starting point, and based on comparison between the reference line 89′ and the straight line 87, a y-axial movement distance is calculated corresponding to the x-coordinate of gravity center of each character whose straight line 87 is to be corrected to the reference line 89′. Alternatively, since the gravity center of each character is calculated already, the Y-axial movement distance may be calculated from the absolute position of the gravity center of each character. Further alternatively, rather than calculating the gravity center of each character, by calculating the Y-axial movement distance corresponding to the X-coordinate of the gravity center of each character whose straight line 87 is to be corrected to the reference line 89′, the aforementioned Y-axial movement distance of each character may be calculated. Then, each of the characters is corrected by adding this Y-axial movement distance. The corrected “trajectory coordinates” are stored in the trajectory storage area 11d as updated coordinates. When the processing in S244 ends, the “correction processing” ends and advances are made to the decision processing in S25.

### ADVANTAGES OF THE EMBODIMENT

The displacement determination means determines a relative displacement of the character written into the aforementioned detection area, and based on this determined displacement, the position correction means corrects the displacement of the character. Therefore, it is possible to provide a head mounted display that can electronically generate a trajectory of characters user desires.

The image of a character string composed of a plurality of characters whose relative displacements are corrected will be output to the image display. This permits the user to confirm how the character displacements are corrected.

Through a user operation, the character displacement correction direction is selected between a first correction mode and a second correction mode. In the first correction mode, displacements with respect to the first direction in the detection area will be corrected. In the second correction mode, the displacements with respect to the second direction, which is perpendicular to this first direction of the detection area, will be corrected. This enables arbitrarily selecting the direction in which character displacements are to be corrected.

The tilt of a character written into the detection area will be corrected based on the information of a tilt of the detection area detected by the tilt detection means. Therefore, even when a character written into the detection area tilts because the detection area is tilted, this tilt can be corrected. It is to be noted that in the case of automatically recognizing characters, the tilt of each of the characters will be corrected, to improve the character recognition accuracy.

In the correction processing, based on the detected acceleration, the characters written in the detection area are moved. Therefore, even when a character in the detection area is displaced because the detection area vibrates, this displacement can be corrected.

When the relative displacement of the characters written into the detection area is a predetermined value or less, this displacement of those characters will not be corrected. Therefore, even when such a small character displacement that the user cannot visually recognize occurs, this character displacement will not be corrected uselessly.

When the neighboring characters overlap with each other, they are moved to such positions that they will not overlap. Therefore, it is possible to eliminate a state in which characters written into the detection area superimposed on each other.

In configuration, the pen 60 may be configured to emit an infrared light or supersonic wave and the input detector 31 may be configured to receive the infrared light or supersonic wave so that the input detector 31 would detect input by the user.

Alternatively, the detection area 31a may be imaged so that input would be detected.

Further alternatively, the input detector 31 might as well be constituted of a pressure-sensitive or electrostatic capacitance type touch panel.

Although in the above embodiments, the user has given an input into the detection area 31a of the input detector 31 by using the pen 60, the user may give an input into the detection area 31a with his finger so that the input detector 31 can detect this input by constituting the input detector 31 of a touch panel or imaging the input detector 31 in configuration.

Although the above embodiments have caused the user to select one of the “vertical correction mode”, the “horizontal correction mode”, and the “displacement not corrected” mode in S11 “main processing” shown in FIG. 4, the pen 60 may be equipped with an operation button 60a so that any one of the modes can be selected by the user manipulating the operation button 60a as shown in FIG. 2. Alternatively, in the processing in S11, the user may manipulate the operation part 35 to select any one of the modes.

It is to be noted that when handwritten characters are entered in English, etc. at the input detector 31, in the decision processing in S21, it is decided whether or not, rather than one character of them, one word as a string made up of them is input completely. When it is decided that the one word as a string of the characters is input completely (YES in S21), advances are made to the processing in S22. On the other hand, when it is not decided that the one word as the string of the characters is input completely (NO in S21), advances are made to the processing in S25.

Although there has been hereinabove described the present invention with reference to the embodiment considered to be most practical and most preferable, it should be appreciated that the present invention is not limited thereto and can be modified appropriately without departing from the gist or the spirit of the present invention perceivable from the claims and the specification as a whole and that a head-mounted display accompanied by those modifications should also be considered to be within the technological scope of the present invention.

What is claimed is:

1. A head-mounted display comprising:
an image display mounted on the head of a user and permits the user to visually recognize an image;
an input detector mounted on the body of the user, and the input detector has a two-dimensional detection area that detects input coordinates which are the coordinates of input by the user;
an operation part that receives an operation of the user;
a processor that executes instructions grouped into functional units, the instructions including:
an image generation unit generating a trajectory image of input based on the input coordinates, and the image generation unit outputs the trajectory image to the image display;
a character selection unit that selects whether the input by the user is a character input through an operation to the operation part;
a displacement determination unit, when the character input is selected by the character selection unit, determining a displacement of the character input into the two-dimensional detection area with respect to a first direction in the two-dimensional detection area by the input coordinates; and
a position correction unit correcting the displacement of the character based on the displacement determined by the displacement determination unit.

2. The head-mounted display according to claim 1, wherein the image generation unit provides the image display with a character string image including a plurality of characters whose relative displacement are corrected by the position correction unit.

3. The head-mounted display according to claim 1, further comprising a correction direction selection unit selecting whether a direction in which the displacement of the characters is to be corrected by the position correction unit is a first mode in which the displacement is corrected with respect to the first direction or a second correction mode in which the displacement is corrected with respect to a second direction, which is the direction perpendicular to the first direction in the two-dimensional detection area, through the operation to the operation part.

4. The head-mounted display according to claim 1, further comprising a tilt detector detecting a tilt of the two-dimensional detection area, wherein:
the position correction unit corrects the tilt of the character input into the two-dimensional detection area based on information of the tilt of the two-dimensional detection area detected by the tilt detector.

5. The head-mounted display according to claim 1, further comprising an acceleration detector detecting an acceleration received by the two-dimensional detection area, wherein:
the position correction unit performs correction of moving the character input into the two-dimensional detection area based on the acceleration.

6. The head-mounted display according to claim 1, when the relative displacement of the character input into the two-dimensional detection area detected by the displacement determination unit is a predetermined value or less, the position correction unit does not correct the displacement of the character.

7. The head-mounted display according to claim 1, further comprising an overlapping decision unit deciding whether the neighboring characters overlap with each other, based on the coordinates of the input, wherein:
when the overlapping decision unit decides that the neighboring characters overlap with each other,
the position correction unit moves the neighboring characters to such positions that they may not overlap with each other, based on the input coordinates.

8. The head-mounted display according to claim 1, wherein the operation part is the input detector.

9. A correction method for correcting a displacement of a character written into a input detector of a head-mounted display having an image display that is mounted on the head of a user and permits the user to visually recognize an image,
an input detector mounted on the body of the user, and the input detector has a two-dimensional detection area that detects input coordinates which are the coordinates of input by the user, and
an operation part that receives operations from the user, the method comprising:
an image generation step of generating a trajectory image of the input based on the coordinates of input and outputting this trajectory image to the image display;
a character selection step of selecting whether or not the character written is selected through the input by the user to the operation part;
a displacement determination step of, when the character written is selected in the character selection step, determining the displacement of the character written into the two-dimensional detection area from the coordinates of input with respect to a first direction in the two-dimensional detection area by the input coordinates; and
a position correction step of correcting the displacement of the character based on the determined displacement.

10. A readable storage medium storing a control program executable on a head-mounted display comprising:
an image display that is mounted on the head of a user and permits the user to visually recognize an image;
an input detector mounted on the body of the user, and the input detector has a two-dimensional detection area that detects input coordinates which are the coordinates of input by the user and
an operation part that receives operations from the user,
the program comprising instructions that cause the head-mounted display to perform the steps of
an image generation step of generating a trajectory image of the input based on the coordinates of input and outputting this trajectory image to said image display;
a character selection step of selecting whether or not the input by the user is a character through the operation to operation part;
a displacement determination step of, when the character written is selected by the character selection unit, determining the displacement of the character written into the two-dimensional detection area from the coordinates of input with respect to a first direction in the two-dimensional detection area by the input coordinates; and
a position correction step of correcting the displacement of the character based on the displacement determined by the displacement determination unit.
